(19) United States
(12) Patent Application Publication
(10) Pub. No.: US 2006/0289821 A1
(43) Pub. Date: Dec. 28, 2006

(54) Drive for pivoting a flap arranged on a vehicle body

(75) Inventor: Andreas Ritter, Hilgert (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/473,206

(22) Filed: Jun. 22, 2006

(30) Foreign Application Priority Data
Jun. 27, 2005 (DE) 102005030053.7-23

(51) Int. Cl. F16K 31/02; F02D 11/10

(52) U.S. Cl. 251/129.13; 123/396

(57) ABSTRACT

A drive for pivoting a flap arranged on a vehicle body about a pivot axis includes a non-self locking electric motor and a drive train connecting the motor to the flap. The motor can be switched between a driving active state and a non-driving inactive state, the motor being moveable in the inactive state at least substantially without any resistance. A braking device blocks the drive train in the inactive state of the drive motor and unblocks the drive train in the active state of the motor.

### BACKGROUND OF THE INVENTION

1. Field of the Invention

The invention relates to a drive for pivoting a flap arranged on a vehicle body about a pivot axis, with a drive motor, by means of which the flap can be driven pivotably via a drive train.

2. Description of the Related Art

In the case of drives of this type which can have an electric motor as the drive motor, the electric motor is designed together with a gear as a self-locking electric motor and interacts with a clutch.

The use of self-locking electric motors together with clutches is expensive and, on account of the increased resistance of the motor, also requires an increased power consumption.

### SUMMARY OF THE INVENTION

It is therefore the object of the invention to provide a cost-effective drive of the type mentioned at the beginning.

According to the invention in that the drive motor can be switched between a driving active state and a non-driving inactive state, the drive motor being moveable in the inactive state at least largely without any resistance. A braking device is arranged in the drive train from the drive motor to the flap, by means of which the drive train can be blocked, the braking device being in a blocking state in the inactive state of the drive motor and being in an unblocking state in the active state of the drive motor. The drive motor is an electric motor which is not self-locking.

Owing to the fact that the drive motor serves only for moving, but not for holding the entirely or partially opened flap, it can be configured in a more simple and cost-effective manner.

The electric motor, which is not self-locking, only has current applied to it and is loaded for the purpose of displacing the flap. When the entirely or partially opened flap is at a standstill, it does not have current applied to it and is unloaded.

A drive of this type may optionally be arranged on one side or else on both sides of the flap, with, in the case of an arrangement on both sides, a braking device being required in just one drive.

In this case, the opening or closing moment of the drive motor can be transmitted in intensified form if a gear is arranged in the drive train upstream and/or downstream of the braking device in the driving direction.

The braking device can be a drive motor which keeps the weight loading by the flap self-locking and is not self-locking when the loading of the flap goes beyond the weight loading by the flap.

However, it is also possible for the braking device to be a gear in the drive train which keeps the weight loading by the flap self-locking and is not self-locking when the loading of the flap goes beyond the weight loading by the flap.

The braking device can also be a braking device to which current can be applied and whose state in which no current is being applied is the blocking state.

An application of current is therefore required only to displace the flap.

The driving movement of the flap can take place in any manner by means of the drive train. It is particularly advantageous and compact if a torque can be transmitted by the drive train.

According to a preferred embodiment, in the inactive state of the drive motor, the transmission loading acting on the drive train can be detected by a sensor. When a certain degree of loading is exceeded, the braking device can be switched into the unblocking state or can be decoupled from the drive motor or the gear. The braking device can be opened by manual actuation of the opened flap and the flap can be moved with customary manual forces. With the braking device released, the simultaneous moving of the drive motor, which is not self-locking, via the drive train only leads to a negligible increase in the manual forces.

In this case, a simple embodiment is for the sensor to be a force sensor or an angle-of-rotation sensor or a Hall sensor.

The sensor can be integrated in a space-saving manner in the drive motor.

By means of an angle-of-rotation sensor, a recognition of obstacles can also be carried out via the sensing of the flap speed.

To compensate for the flap weight, a flap-weight-compensating arrangement can be arranged on the flap and can have a gas-filled spring and/or a spring strut and/or a mechanical spring element as energy accumulator.

In principle, different variants of the compensation of the flap weight are possible. One possibility is for the flap-weight-compensating device to take on the holding function of the flap in the completely opened position. In this case, it is possible for the braking device, after the final position of the flap is reached, to have current applied to it for a period, i.e. for it to be kept in a released state.

In another possibility, the braking device takes over the holding function of the flap in the completely opened position.

Little construction space is required if the drive motor is an electric geared motor with an at least partially integrated gear.

Furthermore, it is also possible, to provide a small construction space, if the braking device is integrated in the drive motor.

Embodiments of the braking device which are advantageously useable consist in the braking device being a band brake or a disc brake.

In this case, the braking device can be under frictional engagement or under positive engagement in the locking state.

For the rapid activation of the braking device, the latter can have an actuating element which can be actuated magnetically, in particular electromagnetically, or is designed as a geared motor.

In order to obtain the braking moment which is certainly adequate but is not overdimensioned in accordance with the respective external conditions, the braking moment of the braking device can be set as a function of the opening angle of the flap and/or of the temperature and/or of the inclination of the vehicle.

If the gear is an epicyclic gear, in particular a planetary gear or a single- or multi-stage spur gear, then the profile of the drive train can be matched to the existing construction-space conditions.

In this case, the gear may comprise a plurality of multi-stage gears.

For the pivoting guidance of the flap, the latter is coupled preferably by means of one or more hinges to the vehicle body in a manner such that it can pivot about the pivot axis.

In this case, a hinge pin of the hinges, which hinge pin is connected in a rotationally fixed manner to a hinge element, can be driven pivotably.

If the flap or the hinge element can be driven pivotably by a flat coupled gear, then a transmission as a function of the flap-opening angle is possible. Another driving possibility is for the flap or the hinge part to be able to be driven pivotably by a cable pull, in particular by a Bowden cable.

A low overall size with a large transmission ratio and an easy manual actuation of the flap with the braking device open is achieved if the planetary gear includes a sun wheel, a fixed internally toothed rim, one or more planet wheels in engagement with the sun wheel and the internally toothed rim, and a planet carrier which carries the planet wheels and is connected in a rotationally fixed manner to a shaft which is coaxial with the axis of rotation of the planet carrier. The rotational movement of a component of the planetary gear can be braked by the braking device or two of the components of the planetary gear can be interlocked. The sun wheel can be driven rotatably by the drive motor and the shaft of the planet carrier forms the output.

As output, an output gearwheel by means of which the flap can be driven pivotably can be arranged on the shaft.

The flap can be driven pivotably by the shaft via a gear stage which may be designed in a construction-space-saving manner as a single- or multi-stage spur gear.

The drive motor is preferably an electric motor, in particular a direct-current motor, which may also be designed, for optimization purposes, as an electric geared motor.

The large transmission ratio which can be achieved is particularly advantageous if the pivot axis extends horizontally.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a drive illustrated in the form of a block diagram, and

FIG. 2 shows a drive with a planetary gear.

### DETAILED DESCRIPTION OF THE PRESENTLY PREFERRED EMBODIMENTS

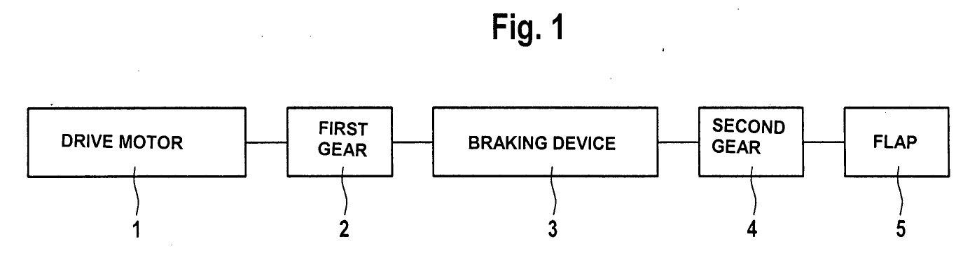

In the case of the exemplary embodiment in FIG. 1, the hinge of a flap 5 is driven pivotably by a drive motor 1, which is not self-locking, via a drive train composed of a first gear 2, a braking device 3, which is closed in the currentless state, and a second gear 4.

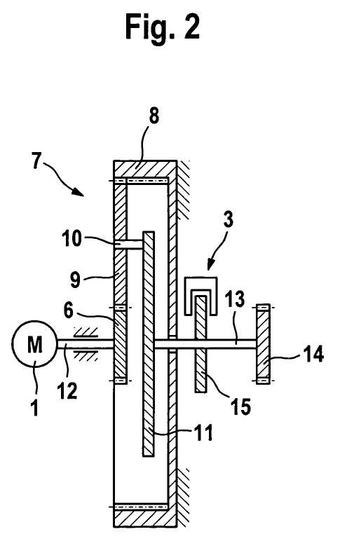

The drive illustrated in FIG. 2 has a drive motor 1, which is designed as an electric motor, is not self-locking and on the output shaft 12 of which a sun wheel 6 of a planetary gear 7 is fixedly arranged. The sun wheel 6 is surrounded concentrically, with a radial clearance, by a fixed internally toothed rim 8 of the planetary gear 7.

A planet wheel 9 arranged between the sun wheel 6 and the internally toothed rim 8 engages both in the teeth of the sun wheel 6 and in the teeth of the internally toothed rim 8.

The planet wheel 9 is mounted rotatably on a journal 10 of a planet carrier 11 which is connected fixedly to a shaft 13 which is coaxial with the output shaft 12 of the drive motor 1 and which carries an output gearwheel 14 for the pivoting drive of a flap (not illustrated), in particular of a vehicle tailgate which is arranged pivotably about a horizontal pivot axis.

A brake disc 15, the rotational movement of which can be braked by a braking device 3, is arranged fixedly on the shaft 13.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive for pivoting a flap arranged on a vehicle body about a pivot axis, the drive comprising:
a non-self locking electric motor that can be switched between a driving active state and a non-driving inactive state, the motor being moveable in the inactive state at least substantially without any resistance;,
a drive train connecting the motor to the flap; and
a braking device which blocks the drive train in the inactive state of the drive motor and unblocks the drive train in the active state of the motor.

2. The drive of claim 1 wherein the braking device is integrated in the electric motor, the motor being self-locking under the weight of the flap and non-self locking when the load on the flap exceeds the weight of the flap.

3. The drive of claim 1 wherein the braking device comprises a gear in the drive train, the gear being self-locking under the weight of the flap and non-self locking when the load on the flap exceeds the weight of the flap.

4. The drive of claim 1 wherein the braking device blocks the drive train when no current is applied to the braking device, and unblocks the drive train when a current is applied to the braking device.

5. The drive of claim 1 further comprising a sensor which can detect a transmission loading acting on the drive train, said braking device unblocking the drive train when a predetermined loading is exceeded.

6. The drive of claim 1 further comprising a flap weight compensating device connected to the flap, said device comprising at least one of a gas filled spring, a spring strut, and a mechanical spring.

7. The drive of claim 1 wherein the motor is a geared electric motor with an at least partially integrated gear.

8. The drive of claim 1 wherein the braking device comprises one of a band brake and a disk brake.

9. The drive of claim 1 wherein the braking device comprises an actuating element which is one of an electromagnetically actuated element and a geared motor.

10. The drive of claim 1 wherein the braking device has a braking moment which can be set as a function of at least one of an opening angle of the flap, a temperature, and an inclination of the vehicle.

11. The drive of claim 1 wherein the flap is coupled to the vehicle body by means of a hinge, said hinge comprising a hinge pin fixed to said flap, said drive train driving said hinge pin to pivot said flap about said pivot axis.

12. The drive train of claim 11 wherein said drive train comprises a flat coupled gear which drives said hinge pin.

13. The drive of claim 1 wherein the drive train comprises a planetary gear arrangement.

14. The drive of claim 13 wherein the planetary gear comprises:
a sun wheel that can be driven rotatably by the drive motor;
a fixed internally toothed rim;
at least one planet wheel engaging the sun wheel and the internally toothed rim; and
a planet carrier which carries the at least one planet wheel and has an axis of rotation, the planet carrier being fixed to a shaft which is coaxial with the axis of rotation and forms the output to the flap;
wherein the braking device blocks the drive train by braking a component of the planetary gear or by interlocking two components of the planetary gear.

15. The drive of claim 14 wherein the drive train further comprises an output gear arranged on the shaft, said output gear driving said flap pivotably.

16. The drive of claim 1 wherein the motor is a direct current motor.

17. The drive motor of claim 16 wherein the motor is a geared electric motor.
